(19) United States
(12) Patent Application Publication
(10) Pub. No.: US 2009/0169999 A1
(43) Pub. Date: Jul. 2, 2009

(54) NON-AQUEOUS ELECTROLYTE SECONDARY BATTERY

(76) Inventors: Masaki Deguchi, Hyogo (JP); Tooru Matsui, Osaka (JP); Hiroshi Yoshizawa, Osaka (JP)

Correspondence Address: MCDERMOTT WILL & EMERY LLP, 600 13TH STREET, NW, WASHINGTON, DC, 20005-3096, US

(21) Appl. No.: 12/096,660

(22) PCT Filed: May 18, 2007
(86) PCT No.: PCT/JP2007/060200

§ 371 Date: Jun. 9, 2008

(30) Foreign Application Priority Data
May 19, 2006 (JP) 2006-140012

(51) Int. Cl. H01M 4/52; H01M 2/16; H02J 7/00

(52) U.S. Cl. 429/223; 429/246; 320/107

(57) ABSTRACT

A non-aqueous electrolyte secondary battery of the present invention includes a positive electrode including a nickel-containing lithium composite oxide as a positive electrode active material, a negative electrode, a separator interposed between the positive electrode and the negative electrode. The separator includes at least one selected from the group consisting of a layer including a polymer of a monomer containing halogen atoms but not containing a hydrogen atom and a layer including an inorganic oxide.

The combination of the foregoing positive electrode including a nickel-containing lithium composite oxide and the foregoing separator makes it possible to suppress the deterioration in the rate performance of the battery when the battery is stored, particularly when the battery is stored under high voltage and high temperature.

### TECHNICAL FIELD

The present invention relates to a non-aqueous electrolyte secondary battery, and particularly relates to a non-aqueous electrolyte secondary battery with improved storage characteristics.

### BACKGROUND ART

In recent years, in the field of non-aqueous electrolyte secondary batteries, lithium ion secondary batteries having a high voltage and a high energy density have been actively studied. For example, in most of commercially available lithium ion secondary batteries, a cobalt-containing lithium composite oxide showing a high charge/discharge voltage (e.g., LiCoO₂) is used as a positive electrode active material. However, there is a strong demand for further improvement in the capacity of batteries, and studies and developments on positive electrode active materials having a higher capacity to replace LiCoO₂ have been actively carried out. Among these, a nickel-containing lithium composite oxide containing nickel as one of its main components (e.g., LiNiO₂) has intensively studied. At present, batteries including a specific nickel-containing lithium composite oxide have been already commercialized.

With respect to the lithium ion secondary batteries, improvement in reliability and longevity is also demanded in addition to improvement in capacity. However, since LiNiO₂ is generally inferior to LiCoO₂ in terms of the cycle performance and the thermal safety, batteries including LiNiO₂ as a positive electrode active material are not yet predominant in the market. Under these circumstances, in order to improve the characteristics of LiNiO₂, improvement of the active material itself has been vigorously studied.

For example, one proposal suggests using LiₐM_{b}Ni_{c}Co_{d}Oₑ (M is at least one metal element selected from the group consisting of Al, Mn, Sn, In, Fe, V, Cu, Mg, Ti, Zn, and Mo, and 0<a<1.3, 0.02≦b≦0.5, 0.02≦d/c+d≦0.9, 1.8<e<2.2, and b+c+d=1) as a positive electrode active material (Patent Document 1). In this nickel-containing lithium composite oxide, the change in crystalline structure in association with charge and discharge is small, and the capacity is high, and the thermal stability is favorable.

Moreover, in order to improve the battery characteristics, improvement of a separator has also been attempted.

Patent Document 2 suggests, in order to improve the safety of batteries in the event of short circuit or in abnormal use, using a separator formed by laminating a porous film made of fluorocarbon resin such as polytetrafluoroethylene and the like, and a polyethylene or polypropylene film. In Patent Document 2, since the separator includes a fluorocarbon resin film having a high melting point, the melting of the separator in the event of abnormal heat generation can be prevented. As such, the safety of batteries can be improved.

Patent Document 3 suggests, in order to improve the safety of batteries including a metallic lithium as a negative electrode active material, using a separator comprising two layers having different pore sizes. The layer having a smaller pore size prevents the dendritic growth of the metallic lithium, and as a result, an internal short circuit that may occur during charge and discharge and an ignition that may occur in association with the internal short circuit can be prevented. Specifically, Patent Document 3 discloses a separator formed by laminating a polytetrafluoroethylene film and a polypropylene film having a small pore size.

Patent Document 4 suggests using a non-woven fabric retaining polyvinylidene fluoride as a separator. The use of the non-woven fabric retaining polyvinylidene fluoride as a separator allows the metallic lithium to be deposited uniformly even during overcharge, making it possible to improve the safety during overcharge.

Patent Document 1: Japanese Laid-Open Patent Publication No. Hei 5-242891
Patent Document 2: Japanese Laid-Open Patent Publication No. Hei 5-205721
Patent Document 3: Japanese Laid-Open Patent Publication No. Hei 5-258741

### Patent Document 4: Japanese Laid-Open Patent Publication No. 2002-042867

### DISCLOSURE OF THE INVENTION

### Problem to be Solved by the Invention

With respect to lithium composite oxides such as a nickel-containing lithium composite oxide and a cobalt-containing lithium composite oxide, it is known that leaching of metals constituting the oxides occurs intensively, particularly when stored under high voltage and high temperature. For example, even when the technique as disclosed in Patent Document 1 is singly used, metal cations leached from the positive electrode active material will be deposited on the negative electrode, and the impedance of the negative electrode may be increased or the clogging of the separator may occur. Consequently, the rate performance after storage of the batteries in such a state is deteriorated.

Even when the separator comprising a polyethylene or polypropylene film and a polytetrafluoroethylene film as suggested in Patent Documents 2 and 3 is used, in the case where LiCoO₂ is used as the positive electrode active material, it is difficult to prevent the leaching of metal cations from the positive electrode active material and the deposition of the leached metal cations on the negative electrode. Alternatively, even when the separator made of non-woven fabric retaining polyvinylidene fluoride as suggested in Patent Document 4 is used, in the case where a nickel-containing lithium composite oxide is used as the positive electrode active material, it is difficult to prevent the leaching of metal cations from the positive electrode active material and the deposition of the leached metal cations on the negative electrode. Because of this, as in the foregoing case, the rate performance after storage of the batteries in such a state as describe above is also deteriorated.

In view of the above, the present invention intends to provide, particularly in the case where a nickel-containing lithium composite oxide is used as the positive electrode active material, a non-aqueous electrolyte secondary battery capable of suppressing the deterioration in the rate performance when stored, particularly when stored under high voltage and high temperature.

### Means for Solving the Problem

The present invention relates to a non-aqueous electrolyte secondary battery comprising a positive electrode including a nickel-containing lithium composite oxide as a positive electrode active material, a negative electrode, a separator interposed between the positive electrode and the negative electrode, and a non-aqueous electrolyte, wherein the separator includes at least one selected from a layer including a polymer of a monomer containing halogen atoms but not containing a hydrogen atom and a layer including an inorganic oxide.

It is preferable that the foregoing nickel-containing lithium composite oxide includes a compound represented by the following formula:

LiNiₓM_{1-x-y}Q_{y}O₂

where M is at least one of Co and Mn, Q is at least one selected from the group consisting of Al, Sr, Y, Zr, Ta, Mg, Ti, Zn, B, Ca, Cr, Si, Ga, Sn, P, V, Sb, Nb, Mo, W, and Fe, 0.1≦x≦1, and 0≦y≦0.1. It is further preferable that in the foregoing nickel-containing lithium composite oxide, Q is at least one selected from the group consisting of Al, Sr, Y, Zr and Ta.

It is preferable that the foregoing polymer is polytetrafluoroethylene.

It is preferable that the foregoing layer including an inorganic oxide includes at least one selected from the group consisting of a polymer containing acrylonitrile units, polyvinylidene fluoride, and polyethersulfone.

It is preferable that a reduction resistant film is provided between the foregoing separator and the negative electrode. It is preferable that the reduction resistant film includes polyolefin. It is further preferable that the polyolefin is polyethylene or polypropylene.

The present invention further relates to a system comprising the foregoing non-aqueous electrolyte secondary battery, and a charger for charging the non-aqueous electrolyte secondary battery, wherein the end-of-charge voltage in the charger is set at 4.3 to 4.6 V.

### EFFECT OF THE INVENTION

In the non-aqueous electrolyte secondary battery of the present invention, the positive electrode active material includes a nickel-containing lithium composite oxide, and the separator includes at least one selected from the group consisting of a layer including a polymer of a monomer containing halogen atoms but not containing a hydrogen atom and a layer including an inorganic oxide. As such, a region where the electron density is high on the surface of the positive electrode active material (oxygen atoms in NiO) and a region where the electron density is high in the separator (halogen atoms and/or oxygen atoms in the inorganic oxide) are opposite to each other, and metal cations having a low electron density can be trapped in the area surrounded by the oxygen atoms in NiO and the halogen atoms and/or the oxygen atoms in the inorganic oxide. This makes it possible to prevent metal cations leached from the positive electrode active material other than lithium ions from being trapped between the positive electrode and the separator and the metal cations from being deposited on the negative electrode, even when the non-aqueous electrolyte secondary battery of the present invention is stored under high voltage and high temperature. Consequently, it becomes possible to suppress the deterioration in the rate performance of the battery when the battery is stored, particularly when the battery is stored under high voltage and high temperature.

### BRIEF DESCRIPTION OF THE DRAWINGS

FIG. 1 A schematic longitudinal sectional view showing a cylindrical non-aqueous electrolyte secondary battery fabricated in Examples.

FIG. 2 A block diagram showing a configuration of a charger with a non-aqueous electrolyte secondary battery of the present invention mounted therein.

### BEST MODE FOR CARRYING OUT THE INVENTION

The best mode for carrying out the present invention is described below in detail.

The non-aqueous electrolyte secondary battery of the present invention includes a positive electrode including a nickel-containing lithium composite oxide as a positive electrode active material, a negative electrode, a separator interposed between the positive electrode and the negative electrode, and a non-aqueous electrolyte. The separator includes at least one selected from the group consisting of a layer including a polymer of a monomer and a layer including an inorganic oxide. The monomers contain halogen atoms but do not contain a hydrogen atom.

The present inventors have searched for the cause of the foregoing problem and conducted further examinations to find out the following. That is, a separator including at least one selected from the group consisting of a layer including a polymer of a monomer containing halogen atoms but not containing a hydrogen atom in their molecules and a layer including an inorganic oxide functions effectively, particularly to a nickel-containing lithium composite oxide serving as a positive electrode active material. In other words, even when a battery including the foregoing positive electrode active material is stored under high voltage and high temperature, it is possible to remarkably prevent metal cations leached from the positive electrode active material other than lithium ions from being deposited on the negative electrode.

The reason for this is considered as follows. By incorporating Ni in the crystalline structure of the positive electrode active material, metal oxide NiO is formed on the surface of the positive electrode active material. Since NiO is a basic oxide, the density of electrons on oxygen atoms in NiO is high. Since the halogen atoms and the oxygen atoms in the inorganic oxide contained in the separator has a high electron-withdrawing property, the electron densities of the halogen atoms and the oxygen atoms in the inorganic oxide are high.

In an arrangement in which the separator and the positive electrode are adjacent to each other, a region where the electron density is high on the surface of the positive electrode active material (oxygen atoms in NiO) and a region where the electron density is high in the separator (halogen atoms and/or oxygen atoms in the inorganic oxide) are opposite to each other. Metal cations having a low electron density can be trapped in the area surrounded by the oxygen atoms in NiO and the halogen atoms and/or the oxygen atoms in the inorganic oxide. This makes it possible to prevent metal cations leached from the positive electrode active material other than lithium ions from being trapped between the positive electrode and the separator and the metal cations from being deposited on the negative electrode, even when the battery is stored under high voltage and high temperature. Consequently, it becomes possible to suppress the deterioration in the rate performance of the battery when the battery is stored, particularly when the battery is stored under high voltage and high temperature.

Patent Document 1 suggests using a nickel-containing lithium composite oxide as the positive electrode active material. However, in the case of using a separator made of polypropylene or polyethylene, metal cations leached from the positive electrode active material cannot be trapped. Because of this, the rate performance of the battery after storage is deteriorated.

In Patent Documents 2 and 3, a separator made of polytetrafluoroethylene (PTFE) is used. However, even with the use of the separator made of PTFE, if the positive electrode active material is LiCoO₂, metal cations leached from the positive electrode active material cannot be trapped. Because of this, in the battery in such a state, the rate performance after storage is deteriorated.

In Patent Document 4, a non-woven fabric retaining polyvinylidene fluoride is used as the separator, and LiNiO₂ is used as the positive electrode active material. However, in the polyvinylidene fluoride, the region where the electron density is high is small. Accordingly, the effect of trapping metal cations leached from the positive electrode active material between the positive electrode and the separator is weak. Because of this, in this case also, the rate performance of the battery after storage is deteriorated.

In the present invention, as the separator, at least one selected from the group consisting of a layer including a polymer of a monomer containing halogen atoms but not containing a hydrogen atom and a layer including an inorganic oxide is used.

Examples of the layer including a polymer of a monomer containing halogen atoms but not containing a hydrogen atom include, for example, a film including the foregoing polymer. Examples of the polymer include, for example, a polymer composed of perfluoroalkylene units, a polymer composed of perchloroalkylene units, and the like. For example, when the polymer is composed of perfluoroalkylene units, one kind of perfluoroalkylene units may be included, or two or more kinds of perfluoroalkylene units may be included. This applies to the case where the polymer is composed of other monomer units (e.g., perchloroalkylene units).

Alternatively, as the foregoing polymer, it is possible to use, in addition to the above, a polymer of a monomer in which a part of a hydrogen atom are replaced with fluorine atoms and the remaining hydrogen atoms are replaced with chlorine atoms (e.g., olefin units in which hydrogen atoms are replaced with fluorine atoms and chlorine atoms), a polymer composed of perfluoroalkyl units and perchloroalkyl units, and the like.

The foregoing polymer is specifically exemplified by, for example, polytetrafluoroethylene, polychlorotrifluoroethylene, tetrafluoroethylene-perfluoroalkyl vinylether copolymer, tetrafluoroethylene-hexafluoropropylene copolymer, and the like.

Among the foregoing polymers, a fluorocarbon polymer such as polytetrafluoroethylene (PTFE) is preferred. Polytetrafluoroethylene contains four fluorine atoms with high electron-withdrawing property in its repeating unit. Moreover, by virtue of little steric hindrance of polymer molecules, the electron densities of the fluorine atoms contained in PTFE are uniform and high in any regions of the polymer. Consequently, metal cations leached from the positive electrode active material can be trapped effectively.

Examples of the layer including an inorganic oxide include, for example, an insulating layer including an inorganic oxide and a polymer material. The polymer material included in the insulating layer is not particularly limited, and exemplified by, for example, a polymer containing acrylonitrile units, polyvinylidene fluoride, polyethersulfone, and the like.

Among these, a polymer containing acrylonitrile units is preferred. It is preferably that in the polymer containing acrylonitrile units, the content of acrylonitrile units is 20 mol % or more. Examples of the polymer containing acrylonitrile units include, for example, polyacrylonitrile, modified polyacrylonitrile rubber, acrylonitrile-styrene-acrylate copolymer, and the like. The use of the polymer containing acrylonitrile units as the polymer material can improve the dispersibility of the inorganic oxide and the polymer material in the insulating layer. Consequently, it becomes possible for the insulating layer to efficiently trap the metal cations.

When a layer including an inorganic oxide is used as the separator, the layer including an inorganic oxide may be disposed over an entire face opposite to the positive electrode in the negative electrode, or may be disposed over an entire face opposite to the negative electrode in the positive electrode.

In the insulating layer, the content of the inorganic oxide is preferably 80 to 99 wt %. When the content of the inorganic oxide is less than 80 wt %, the gaps in the layer is decreased and the lithium ion conductivity is lowered. When the content of the inorganic oxide is more than 99 wt %, the strength of the insulating layer itself is lowered.

Examples of the inorganic oxide include alumina, titania, zirconia, magnesia, silica, and the like.

It is preferable that the thickness of the separator is 0.5 to 300 μm. This applies to the case where the separator is formed of the layer including a polymer of a monomer, as well as where the separator is formed of the layer including an inorganic oxide. When the separator includes both the layer including a polymer and the layer including an inorganic oxide, it is preferable that the total thickness of these two layers is 0.5 to 300 μm.

It is preferable that the separator is arranged so as not to be in direct contact with the negative electrode.

For example, in the case where the separator contains halogen atoms with high electron-withdrawing property, the carbon atom portions forming the polymer skeleton are in a state in which the electron density is slightly low because of the high electron-withdrawing property of the halogen atoms. For this reason, if the potential of the negative electrode is significantly lowered, the carbon atom portions may be easily reduced.

In order to prevent such a reduction of the carbon atom portions, it is preferable, for example, to arrange a reduction resistant film between the negative electrode and the separator. This makes it possible to suppress the deterioration in the rate performance after storage.

For the reduction resistant film, it is possible to use, for example, a polyolefin film. Examples of the polyolefin film include, for example, a polyethylene film, a polypropylene film, and the like.

Further, in the case where the separator is formed only of the layer including an inorganic oxide, providing the reduction resistant film between the separator and the negative electrode makes it possible to further suppress the deterioration in the rate performance of the battery after storage.

It should be noted that the layer including an inorganic oxide is capable of functioning similarly to the reduction resistant film, although inferior in its effectiveness. For this reason, when the separator includes both the layer including a polymer and the layer including an inorganic oxide, by providing the layer including an inorganic oxide between the layer including a polymer and the negative electrode, the reduction of the layer including a polymer can be inhibited.

In this case, the layer including an inorganic oxide may be formed on a face opposite to the negative electrode in the layer (film) including a polymer, or alternatively, on a face opposite to the layer (film) including a polymer in the negative electrode.

It is preferable that the thickness of the reduction resistant film is 0.5 to 25 μm. When the thickness of the reduction resistant film and the reduction resistant layer is less than 0.5 μm, the reduction resistant film or the reduction resistant layer is crushed by the pressure applied thereto when the positive electrode, the negative electrode, the separator, and the reduction resistant film or the reduction resistant layer are wound, bringing the separator and the negative electrode into contact with each other. This may make the effect of inhibiting the reduction of the separator insufficient. When the thickness of the reduction resistant film and the reduction resistant layer is more than 25 μm, the output performance may be deteriorated because of an extremely large DC resistance.

An example of a method of fabricating a separator is described below.

A polymer of a monomer containing halogen atoms but not containing a hydrogen atom is mixed with an organic solvent. The polymer is melted and kneaded, extrusion-molded, and then subjected to drawing, removing of the organic solvent, drying, and thermosetting, whereby a separator can be obtained.

For example, a separator can be obtained by the method as described below.

First, the polymer and a good solvent for the polymer are mixed to prepare a solution of the polymer.

The polymer solution serving as a starting material can be prepared by, for example, heating and dissolving the polymer in a predetermined solvent. No particular limitation is imposed on the solvent as long as it can dissolve the polymer sufficiently. Examples of the solvent include, for example, aliphatic or cyclic hydrocarbons such as nonane, decane, undecane, dodecane, and liquid paraffin, mineral oil fractions having a boiling point at the same level as the boiling points of these hydrocarbons, and the like. In order to improve the stability of a gel-like molded material obtained after the extrusion-molding, it is preferable to use a nonvolatile solvent such as liquid paraffin.

The heating and dissolving may be performed while the polymer is being stirred at a temperature at which the polymer is completely dissolved in the solvent, or while the polymer is being mixed uniformly in an extruder. In the case where the dissolving is performed while the polymer is being stirred in the solvent, the heating temperature, although varied depending on the types of the polymer and the solvent to be used, is usually in a range of 140 to 250° C.

In the case where the dissolving is performed in an extruder, first, the polymer is supplied to the extruder to be melted. The melting temperature, although varied depending on the type of the polymer to be used, is preferably 30 to 100° C. higher than the melting point of the polymer.

Subsequently, a predetermined solvent is supplied to this molten polymer. In such a manner, a heated solution of molten polymer can be obtained.

Next, this solution is extruded into a sheet through the dies on the extruder, and then cooled to obtain a gel-like composite. It should be noted that in the case where the polymer solution is prepared in the extruder, the solution may be extruded from the extruder through dies and the like, or the solution may be transferred to another extruder and extruded through dies and the like.

Subsequently, by performing cooling, a gel-like molded material is formed. The cooling is performed by cooling the dies or cooling the gel-like sheet. It is preferable to cool down to 90° C. or less at a rate of at least 50° C./min, and more preferable to cool down to 80 to 30° C. As a method of cooling the gel-like sheet, it is possible to use a method of bringing the gel-like sheet into direct contact with a cooling medium such as cold air or cooling water, a method of bringing the gel-like sheet into contact with a roller cooled with a cooling medium, and other methods. Among these, a method of using a cooling roller is preferred.

Next, this gel-like molded material is subjected to biaxial drawing to obtain a molded material. The drawing is performed at a predetermined magnification after the gel-like molded material is heated, with a typical method such as a tenter method, a roll method, and a rolling method, or a combination of these methods. The biaxial drawing may be either one of a lengthwise and crosswise simultaneous drawing, and a sequential drawing, but a simultaneous biaxial drawing is particularly preferred.

The molded material obtained in the manner as described above is washed with a washing agent to remove the residual solvent. As the washing agent, it is possible to use an easily volatile solvent, which is exemplified by hydrocarbons such as pentane, hexane and heptane, chlorinated hydrocarbons such as methylene chloride and carbon tetrachloride, fluorinated hydrocarbons such as trifluoroethane, ethers such as diethyl ether and dioxane, and the like. These may be used singly or in combination of two or more. It should be noted that from the above, one or more suitable ones are selected as the washing agent depending on the solvent used for dissolving the polymer.

Examples of the method for washing the molded material include, for example, a method of immersing the molded material in a predetermined washing agent to extract the residual solvent, a method of showering the washing agent to the molded material, a method using these in combination, and the like.

It is preferable to wash the molded material until the content of residual solvent in the molded material becomes less than 1 wt %.

Thereafter, the molded material is dried to remove the washing agent. The drying can be performed, for example, with the use of a method of heat drying, air drying, and the like.

Lastly, the molded material after the drying is subjected to thermosetting at a temperature of 100° C. or more, whereby a separator which is a microporous film with high strength can be obtained.

The positive electrode includes, for example, a positive electrode current collector and a positive electrode active material layer carried thereon. The positive electrode active material layer includes a nickel-containing lithium composite oxide serving as a positive electrode active material, and, as needed, a binder, a conductive agent, and the like.

For the positive electrode active material, it is preferable to use a nickel-containing lithium composite oxide represented by the following formula:

LiNiₓM_{1-x-y}Q_{y}O₂

where M is at least one of Co and Mn, Q is at least one selected from the group consisting of Al, Sr, Y, Zr, Ta, Mg, Ti, Zn, B, Ca, Cr, Si, Ga, Sn, P, V, Sb, Nb, Mo, W, and Fe, 0.1≦x≦1, and 0≦y≦0.1. Such a compound has a stable crystalline structure and thus is capable of providing excellent battery performances. The molar ratio x of nickel is preferably in a range of 0.3≦x≦0.9, and more preferably in a range of 0.7≦x≦0.9. It should be noted that in the foregoing compound, the molar ratio of lithium is increased or decreased in association with charge and discharge.

If the molar ratio y of element Q exceeds 0.1, regardless of which element among the foregoing elements is element Q, the function of metal oxide NiO as an electron donor is excessively activated. Because of this, the difference in electron density between a region having a high electron density on the surface of the positive electrode active material and a region having a high electron density in the separator is remarkably increased. As a result, the effect of trapping metal cations leached from the positive electrode active material is weakened. It is preferable therefore that the molar ratio y is preferably 0.1 or less.

It is preferable that element Q is at least one selected from the group consisting of Al, Sr, Y, Zr, and Ta among the foregoing elements. A metal oxide produced from these elements, such as Al₂O₃ and SrO, has an effect of moderately enhancing the function of the metal oxide NiO as an electron donor. The inclusion of an oxide of the foregoing elements in the positive electrode active material allows the electron density in the region having a high electron density on the surface of the positive electrode active material to be substantially equal to the electron density of the halogen atoms in the separator or the electron density of the oxygen atoms in the inorganic oxide. It is considered that this further improves the effect of trapping the metal cations leached from the positive electrode active material, making it possible to obtain further favorable storage characteristics.

The negative electrode includes, for example, a negative electrode current collector and a negative electrode active material layer carried thereon. The negative electrode active material layer includes a negative electrode active material, and, as needed, a binder, a conductive agent, and the like. For the negative electrode active material, it is preferable to use, for example, graphites such as natural graphite (flake graphite etc.) and artificial graphite, carbon blacks such as acetylene black, Ketjen Black, channel black, furnace black, lampblack, and thermal black, a carbon fiber, a metal fiber, an alloy, a lithium metal, a tin compound, a silicon compound, a nitride, and the like.

For the binder to be used in the positive electrode and the negative electrode, for example, polyethylene, polypropylene, polytetrafluoroethylene, polyvinylidene fluoride, tetrafluoroethylene-hexafluoropropylene copolymer, vinylidene fluoride-hexafluoropropylene copolymer, and the like are used. Here, it is preferable that the binder to be added to the positive electrode is made of a material that contains fluorine atoms, and the binder to be added to the negative electrode is made of a material that does not contain fluorine atoms.

For the conductive agent to be contained in the electrodes, for example, graphites, carbon blacks such as acetylene black, Ketjen Black, channel black, furnace black, lampblack, and thermal black, a carbon fiber, a metal fiber, and like are used.

For the positive electrode current collector, for example, a sheet made of stainless steel, aluminum, titanium, or the like is used. For the negative electrode current collector, for example, a sheet made of stainless steel, nickel, cupper, or the like is used. The thickness of these, although not particularly limited, is preferably 1 to 500 μm.

The non-aqueous electrolyte includes a non-aqueous solvent and a solute dissolved in the non-aqueous solvent. For the non-aqueous solvent, it is possible to use, for example, a cyclic carbonic acid ester, a chain carbonic acid ester, a cyclic carboxylic acid ester, and the like. The cyclic carbonic acid ester is exemplified by propylene carbonate, ethylene carbonate, and the like. The chain carbonic acid ester is exemplified by diethyl carbonate, ethyl methyl carbonate, dimethyl carbonate, and the like. The cyclic carboxylic acid ester is exemplified by γ-butyrolactone, γ-valerolactone, and the like. These non-aqueous solvents may be used singly or in combination of two or more.

As the solute to be dissolved in the non-aqueous solvent, it is possible to use, for example, LiPF₆, LiClO₄, LiBF₄, LiAlCl₄, LiSbF₆, LiSCN, LiCF₃SO₃, LiCF₃CO₂, Li(CF₃SO₂)₂, LiAsF₆, LiB₁₀Cl₁₀, lithium lower aliphatic carboxylate, LiCl, LiBr, LiI, chloroborane lithium such as Li₂B₁₀Cl₁₀, borates such as lithium bis(1,2-benzenediolate(2-)-O,O′) borate, lithium bis(2,3-naphtalenediolate(2-)-O,O′) borate, lithium bis(2,2′-biphenyldiolate(2-)-O,O′) borate, and lithium bis(5-fluoro-2-olate-1-benzenesulfonate-O,O′) borate, and imides such as lithium bis(trifluoromethane) sulfonylimide ((CF₃SO₂)₂NLi), lithium trifluoromethane sulfonyl nonafluorobutane sulfonylimide (LiN(CF₃SO₂)(C₄F₉SO₂)), and lithium bispentafluoroethane sulfonylimide ((C₂F₅SO₂)₂NLi), and the like. These may be used singly or in combination of two or more.

Moreover, it is preferable to include a cyclic carbonic acid ester having at least one carbon-carbon unsaturated bond in the non-aqueous electrolyte. Such a cyclic carbonic acid ester is decomposed on the negative electrode to form a coating film with high lithium ion conductivity. This makes it possible to improve the charge/discharge efficiency of the battery. The content of the cyclic carbonic acid ester having at least one carbon-carbon unsaturated bond is preferably 10 vol % or less of the non-aqueous solvent.

Examples of the cyclic carbonic acid ester having at least one carbon-carbon unsaturated bond include, for example, vinylene carbonate, 4-methyl vinylene carbonate, 4,5-dimethyl vinylene carbonate, 4-ethyl vinylene carbonate, 4,5-diethyl vinylene carbonate, 4-propyl vinylene carbonate, 4,5-dipropyl vinylene carbonate, 4-phenyl vinylene carbonate, 4,5-diphenyl vinylene carbonate, vinyl ethylene carbonate, divinyl ethylene carbonate, and the like. These may be used singly or in combination of two or more. Among these, at least one selected from the group consisting of vinylene carbonate, vinyl ethylene carbonate, and divinyl ethylene carbonate is preferred. In these compounds, a part of hydrogen atoms may be replaced with fluorine atoms.

The non-aqueous electrolyte may further include a known benzene derivative that is decomposed to form a coating film on the electrode during overcharge, thereby inactivates the battery. As the foregoing benzene derivative, a compound having a phenyl group and a cyclic compound group adjacent to the phenyl group is preferred. As the cyclic compound group, a phenyl group, a cyclic ether group, a cyclic ester group, a cycloalkyl group, a phenoxy group, and the like are preferred. The benzene derivative is specifically exemplified by cyclohexylbenzene, biphenyl, diphenyl ether, and the like. These may be used singly or in combination of two or more. The content of the benzene derivative is preferably 10 vol 6 or less of the non-aqueous solvent.

It is preferable that the end-of-charge voltage of the non-aqueous electrolyte secondary battery of the present invention in a normal operating state is set at 4.3 to 4.6 V. In other words, it is preferable that in a system comprising the non-aqueous electrolyte secondary battery of the present invention and a charger for charging the same (e.g., a cellular telephone and a personal computer), the end-of-charge voltage in the charger is set at 4.3 to 4.6 V.

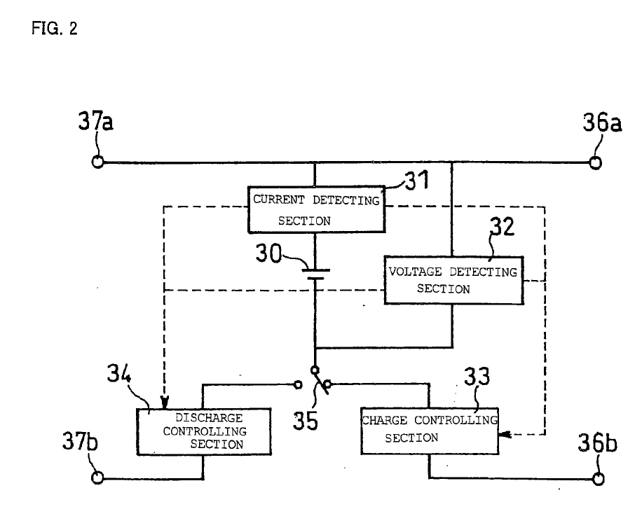

FIG. 2 illustrates a block diagram showing an example of a configuration of a charger for controlling the charge of a battery. The charger shown in FIG. 2 also includes a discharge controller.

In this charger, a non-aqueous electrolyte secondary battery 30 of the present invention and a current detecting section 31 are connected in series. A voltage detecting section 32 is connected in parallel to the circuit in which the battery 30 and the current detecting section 31 are connected in series.

This charger further includes input terminals 36a and 36b for charging the battery 30, and output terminals 37a and 37b to be connected to equipment. Moreover, this charger includes a select switch 35 connected in series to the battery 30. The switch 35 is turned to the side of a charge controlling section 33 for charge, and turned to the side of a discharge controlling section 34 for discharge.

The degree of expansion of the nickel-containing composite oxide serving as a positive electrode active material is increased as the end-of-charge voltage is set higher. By virtue of this, the non-aqueous electrolyte is allowed to easily enter the interior of the electrode, and the contact between the positive electrode and the non-aqueous electrolyte is improved. As a result, a local increase in voltage in the electrode is suppressed, and thus the voltage is smoothed.

When the end-of-charge voltage is lower than 4.3 V, since the degree of expansion of the positive electrode active material is low, only a small amount of non-aqueous electrolyte can enter the interior of the electrolyte. The charge reaction therefore proceeds on the surface of the electrode more intensively than in the interior, causing a local voltage increase. Consequently, the non-aqueous solvent is decomposed by oxidation, and the transition metal elements contained in the positive electrode active material are reduced. As a result, a great amount of the reduced transition metal elements may be leached from the positive electrode active material as metal cations. When the end-of-charge voltage is higher than 4.6 V, a local voltage increase can be suppressed, but because of the excessively high voltage, there may occur oxidation decomposition of the non-aqueous solvent as well as reduction of the transition metal elements contained in the positive electrode active material. Consequently, in this case also, a great amount of metal cations may be leached from the positive electrode active material.

### EXAMPLES

### Example 1

### Battery 1

### (i) Preparation of Non-Aqueous Electrolyte

In a mixture solvent of ethylene carbonate (EC) and ethyl methyl carbonate (EMC) (volume ratio 1:4), LiPF₆ was dissolved in a concentration of 1.0 mol/L, to prepare a non-aqueous electrolyte.

### (ii) Separator

A separator made of polytetrafluoroethylene (PTFE) available from W. L. Gore & Associates, Inc.) was used. The thickness of the separator made of PTFE was 54 μm, and the porosity thereof was 61%.

(iii) Fabrication of Positive Electrode Plate

85 parts by weight of LiNi_{0.8}Co_{0.2}O₂ powder serving as a positive electrode active material, 10 parts by weight of acetylene black serving as a conductive agent, and 5 parts by weight of polyvinylidene fluoride resin serving as a binder were mixed. The resultant mixture was dispersed in an appropriate amount of dehydrated N-methyl-2-pyrrolidone, whereby a positive electrode material mixture slurry was prepared. This positive electrode material mixture was applied onto both faces of a positive electrode current collector made of an aluminum foil (thickness: 15 μm) and then dried and rolled to give a positive electrode plate (thickness: 160 μm).

### (iv) Fabrication of Negative Electrode Plate

100 parts by weight of artificial graphite powder, 1 part by weight of polyethylene resin serving as a binder, and 1 part by weight of carboxymethyl cellulose serving as a thickener were mixed. To the resultant mixture, an appropriate amount of water was added and kneaded, whereby a negative electrode material mixture slurry was prepared. This negative electrode material mixture was applied onto both faces of a negative electrode current collector made of a copper foil (thickness: 10 μm) and then dried and rolled to give a negative electrode plate (thickness: 160 μm).

### (v) Production of Cylindrical Battery

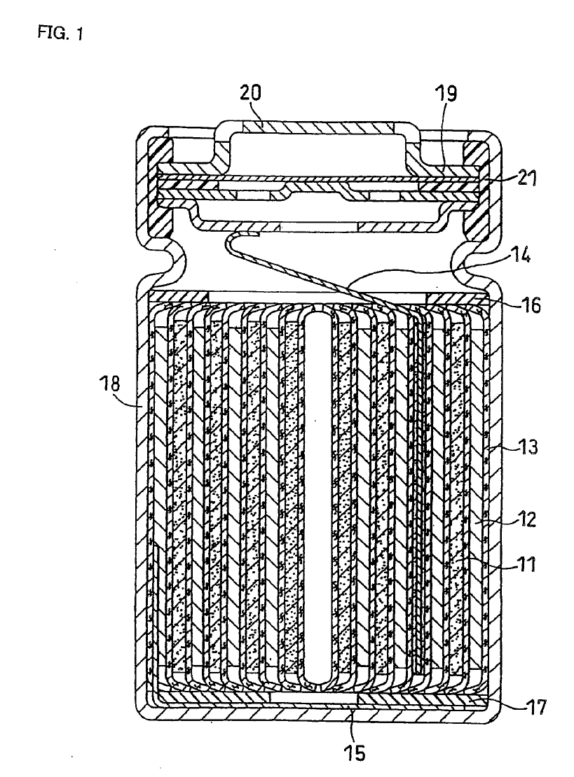

A cylindrical battery as shown in FIG. 1 was assembled.

A positive electrode plate 11, a negative electrode plate 12, and a separator 13 interposed between the positive electrode plate 11 and the negative electrode plate 12 were wound in a coil to fabricate an electrode plate assembly. The electrode plate assembly was housed in a nickel-plated battery case 18 made of iron. One end of a positive electrode lead 14 made of aluminum was connected to the positive electrode plate 11, and the other end of the positive electrode lead 14 was connected to the back face of a sealing plate 19 electrically connected to a positive electrode terminal 20. One end of a negative electrode lead 15 made of nickel was connected to the negative electrode plate 12, and the other end of the negative electrode lead 15 was connected to the bottom of the battery case 18. On the upper portion and the lower portion of the electrode plate assembly, an upper insulating plate 16 and a lower insulating plate 17 were provided, respectively. A predetermined amount of non-aqueous electrolyte (not shown) prepared in the manner as described above was injected into the battery case 18. The opening end of the battery case 18 was crimped onto the sealing plate 19 with a gasket 21 therebetween to seal the opening of the battery case 18, whereby a battery 1 was finished. The design capacity of the battery 1 was 1500 mAh. It should be noted that in the following Examples, the design capacity of the battery was 1500 mAh.

### Battery 2

Battery 2 was fabricated in the same manner as Battery 1 except that an insulating layer including a polymer containing acrylonitrile units (PAN) and including alumina (PAN-containing insulating layer) was used as the separator.

The PAN-containing insulating layer was fabricated in the following procedures.

970 g of alumina having a median diameter of 0.3 μm was stirred using a double-arm kneader together with 375 g of modified polyacrylonitrile rubber binder (BM-720H (solid content concentration: 8 wt %) available from Zeon Corporation, Japan) and an appropriate amount of N-methyl-2-pyrrolidone, whereby a paste was prepared. This paste was applied onto both of the negative electrode active material layers in a thickness of 20 μm, dried, and then further dried at 120° C. for 10 hours under vacuum reduced pressure. In such a manner, the PAN-containing insulating layer was formed.

### Comparative Example 1

Comparative Battery 1 was fabricated in the same manner as Battery 1 except that a separator made of polyethylene (PE) was used.

### Comparative Example 2

Comparative Battery 2 was fabricated in the same manner as Battery 1 except that a separator made of polyvinylidene fluoride (PVDF) was used.

### Comparative Example 3

Comparative Battery 3 was fabricated in the same manner as Battery 1 except that lithium cobalt oxide (LiCoO₂) was used as the positive electrode active material.

### Comparative Example 4

Comparative Battery 4 was fabricated in the same manner as Battery 2 except that lithium cobalt oxide (LiCoO₂) was used as the positive electrode active material.

### Comparative Example 5

Comparative Battery 5 was fabricated in the same manner as Battery 1 except that LiCoO₂ was used as the positive electrode active material, and a separator made of PE was used.

The separator made of PE and the separator made of PVDF were fabricated in the following manner.

Each polymer was dissolved in a predetermined organic solvent to prepare a polymer solution. This solution was extruded in a sheet through the dies on an extruder. Subsequently, the extruded sheet was cooled down to 90° C. or less at a cooling rate of 50° C./min to obtain a gel-like molded material.

Subsequently, the gel-like molded material was subjected to biaxial drawing at a predetermined magnification to obtain a molded material. The resultant molded material was then washed with a washing agent until the content of residual solvent in the molded material became less than 1 wt %. The washing agent was varied depending on the type of the solvent used.

Thereafter, the molded material was dried to remove the washing agent.

Lastly, the molded material after drying was subjected to thermosetting at a temperature of 100° C. or more, whereby a separator was obtained. The thickness of these separators was 54 μm, and the porosity was 61%.

### [Evaluation]

(a) Measurement of Amount of Metal Deposited on Negative Electrode after Storage

Batteries 1 to 2 and Comparative Batteries 1 to 5 fabricated in the manner as described above were charged at a constant voltage of 4.3 V. The batteries after charge were stored at 85° C. for 72 hours.

Thereafter, the batteries after storage were disassembled, and the center portion of the negative electrode plate was cut out in a size of 2 cm×2 cm. The piece thus obtained was washed three times with ethyl methyl carbonate.

Subsequently, the piece and an acid added thereto were heated to dissolve the piece. Insoluble components were filtered off, and the filtrate was brought to a constant volume to be used as a measurement sample. This measurement sample and an ICP emission spectrophotometer (VISTA-RL available from VARIAN, Inc.) were used to quantitate the amount of metal leached from the positive electrode and deposited on the negative electrode. Here, in Batteries 1 to 2 and Comparative Examples 1 to 2, the amounts of Ni and Co were quantitated, and the total of these amounts was referred to as an amount of metal deposited on the negative electrode. In Comparative Examples 3 to 5, the amount of Co was quantitated, and the amount of Co was referred to as an amount of metal deposited on the negative electrode. The results are shown in Table 1. In Table 1, the amount of metal deposited (metal deposition amount) is converted into an amount per unit weight of the negative electrode.

### (b) Capacity Recovery Rate

First, each battery was subjected to constant-current constant-voltage charge in which charge was performed at a constant current of 1050 mA at 20° C. until the battery voltage reached 4.3 V, and then at a constant voltage of 4.3 V for 2.5 hours. Subsequently, the battery after charge was discharged at a discharge current value of 1500 mA (1 C) until the battery voltage dropped to 3.0 V, and a discharge capacity before storage was determined.

Next, the battery after discharge was charged in the same manner as described above. The battery after charge was stored at 85° C. for 72 hours.

The battery after storage was first discharged at a current value of 1 C at 20° C. and then further discharged at a current value of 0.2 C. Subsequently, the battery after discharge was charged in the same manner as described above at a constant current of 1050 mA until the battery voltage reached 4.3 V and then charged at a constant voltage of 4.3 V for 2.5 hours. Thereafter, the battery after charge was discharged at a current value of 1 C until the battery voltage dropped to 3.0 V. The discharge capacity at this time was referred to as a recovery capacity after storage.

The proportion of a recovery capacity after storage relative to a discharge capacity before storage was calculated as a percentage, which was referred to as a capacity recovery rate after storage. The results are shown in Table 1. The types of the positive electrode active material and the separator used are also shown in Table 1.

TABLE 1

| | | | Metal | |
|---|---|---|---|---|
| | | | deposition | |
| | Positive | | amount | Capacity |
| | electrode | Constituent | after | recovery |
| | active | material of | storage | rate |
| | material | separator | (μg/g) | (%) |
| Battery 1 | LiNi_{0.8}Co_{0.2}O₂ | PTFE | 8.9 | 84.0 |
| Battery 2 | LiNi_{0.8}Co_{0.2}O₂ | PAN-containing | 9.1 | 83.8 |
| | | insulating layer | | |
| Comparative | LiNi_{0.8}Co_{0.2}O₂ | PE | 73 | 39.5 |
| Battery 1 | | | | |
| Comparative | LiNi_{0.8}Co_{0.2}O₂ | PVDF | 25 | 61.6 |
| Battery 2 | | | | |
| Comparative | LiCoO₂ | PTFE | 70 | 40.6 |
| Battery 3 | | | | |
| Comparative | LiCoO₂ | PAN-containing | 71 | 40.2 |
| Battery 4 | | insulating layer | | |
| Comparative | LiCoO₂ | PE | 75 | 38.1 |
| Battery 5 | | | | |

In Battery 1 for which LiNi_{0.8}Co_{0.2}O₂ was used as the positive electrode active material and the separator made of PTFE was used, and Battery 2 for which LiNi_{0.8}Co_{0.2}O₂ was used as the positive electrode active material and the PAN-containing insulating layer was used, the metal deposition amount after storage was decreased and the capacity recovery rate was favorable. Presumably, this was because metal cations leached from the positive electrode were trapped in an area surrounded by a region where the electron density was high on the surface of the positive electrode active material (oxygen atoms in NiO) and a region where the electron density was high in the separator made of PTFE (fluorine atoms) or a region where the electron density was high in the PAN-containing insulating layer (oxygen atoms in alumina).

On the other hand, the metal deposition amounts after storage in Comparative Batteries 1 to 5 were great as compared with those in Batteries 1 to 2. Moreover, the capacity recovery rates in Comparative Batteries 1 to 5 were low as compared with those in Batteries 1 to 2.

### Example 2

### Batteries 3 to 50

Batteries 3 to 50 were fabricated in the same manner as Battery 1 except that nickel-containing lithium composite oxides having a composition as shown in Table 2 were used as the positive electrode active material.

With respect to Batteries 3 to 50, the metal deposition amount after storage and the capacity recovery rate were measured in the same manner as described above. In the measurement of the metal deposition amount after storage, in the case where the positive electrode active material included Ni only among Ni, Co and Mn, the amount of Ni was referred to as the metal deposition amount. In the case where the positive electrode active material included Ni and Co, the total amount of Ni and Co was referred to as the metal deposition amount. In the case where the positive electrode active material included Ni and Mn, the total amount of Ni and Mn was referred to as the metal deposition amount. In the case where the positive electrode active material included Ni, Co and Mn, the total amount of Ni, Co and Mn was referred to as the metal deposition amount. The results are shown in Tables 2 and 3. It should be noted that Battery 9 and Battery are identical to each other.

TABLE 2

| | | | Metal | |
|---|---|---|---|---|
| | | | deposition | |
| | Positive | Con- | amount | Capacity |
| | electrode | stituent | after | recovery |
| | active | material of | storage | rate |
| | material | separator | (μg/g) | (%) |
| Battery 3 | LiNi_{0.005}Co_{0.995}O₂ | PTFE | 14 | 80.4 |
| Battery 4 | LiNi_{0.05}Co_{0.95}O₂ | PTFE | 13 | 80.8 |
| Battery 5 | LiNi_{0.1}Co_{0.9}O₂ | PTFE | 11 | 82.6 |
| Battery 6 | LiNi_{0.3}Co_{0.7}O₂ | PTFE | 10 | 82.9 |
| Battery 7 | LiNi_{0.5}Co_{0.5}O₂ | PTFE | 9.9 | 83.3 |
| Battery 8 | LiNi_{0.7}Co_{0.3}O₂ | PTFE | 9.2 | 83.8 |
| Battery 9 | LiNi_{0.8}Co_{0.2}O₂ | PTFE | 8.9 | 84.0 |
| Battery 10 | LiNi_{0.9}Co_{0.1}O₂ | PTFE | 9.3 | 83.7 |
| Battery 11 | LiNiO₂ | PTFE | 11 | 82.2 |
| Battery 12 | LiNi_{0.8}Co_{0.15}Al_{0.05}O₂ | PTFE | 7.0 | 86.1 |
| Battery 13 | LiNi_{0.82}Co_{0.15}Al_{0.03}O₂ | PTFE | 7.3 | 85.7 |
| Battery 14 | LiNi_{0.84}Co_{0.15}Al_{0.01}O₂ | PTFE | 7.6 | 85.5 |
| Battery 15 | LiNi_{0.845}Co_{0.15}Al_{0.005}O₂ | PTFE | 8.0 | 85.2 |
| Battery 16 | LiNi_{0.8}Co_{0.15}Sr_{0.05}O₂ | PTFE | 7.2 | 85.9 |
| Battery 17 | LiNi_{0.8}Co_{0.15}Y_{0.05}O₂ | PTFE | 7.2 | 85.8 |
| Battery 18 | LiNi_{0.8}Co_{0.15}Zr_{0.05}O₂ | PTFE | 7.1 | 86.0 |
| Battery 19 | LiNi_{0.8}Co_{0.15}Ta_{0.05}O₂ | PTFE | 7.3 | 85.7 |
| Battery 20 | LiNi_{0.8}Co_{0.15}Mg_{0.05}O₂ | PTFE | 9.8 | 83.3 |
| Battery 21 | LiNi_{0.8}Co_{0.15}Ti_{0.05}O₂ | PTFE | 11 | 82.8 |
| Battery 22 | LiNi_{0.8}Co_{0.15}Zn_{0.05}O₂ | PTFE | 11 | 82.6 |
| Battery 23 | LiNi_{0.8}Co_{0.15}B_{0.05}O₂ | PTFE | 10 | 83.0 |
| Battery 24 | LiNi_{0.8}Co_{0.15}Ca_{0.05}O₂ | PTFE | 9.8 | 83.2 |
| Battery 25 | LiNi_{0.8}Co_{0.15}Cr_{0.05}O₂ | PTFE | 12 | 82.1 |
| Battery 26 | LiNi_{0.8}Co_{0.15}Si_{0.05}O₂ | PTFE | 12 | 82.0 |
| Battery 27 | LiNi_{0.8}Co_{0.15}Ga_{0.05}O₂ | PTFE | 12 | 82.3 |
| Battery 28 | LiNi_{0.8}Co_{0.15}Sn_{0.05}O₂ | PTFE | 12 | 82.2 |
| Battery 29 | LiNi_{0.8}Co_{0.15}P_{0.05}O₂ | PTFE | 13 | 81.3 |
| Battery 30 | LiNi_{0.8}Co_{0.15}V_{0.05}O₂ | PTFE | 13 | 81.4 |
| Battery 31 | LiNi_{0.8}Co_{0.15}Sb_{0.05}O₂ | PTFE | 12 | 82.0 |
| Battery 32 | LiNi_{0.8}Co_{0.15}Nb_{0.05}O₂ | PTFE | 12 | 81.8 |
| Battery 33 | LiNi_{0.8}Co_{0.15}Mo_{0.05}O₂ | PTFE | 11 | 82.5 |
| Battery 34 | LiNi_{0.8}Co_{0.15}W_{0.05}O₂ | PTFE | 12 | 81.9 |
| Battery 35 | LiNi_{0.8}Co_{0.15}Fe_{0.05}O₂ | PTFE | 13 | 81.4 |

TABLE 3

| | | | Metal | |
|---|---|---|---|---|
| | | | depo- | |
| | | Con- | sition | |
| | | stituent | amount | Capacity |
| | | material | after | recovery |
| | Positive electrode | of sep- | storage | rate |
| | active material | arator | (μg/g) | (%) |
| Battery 36 | LiNi_{0.8}Co_{0.15}Al_{0.03}Zr_{0.02}O₂ | PTFE | 6.9 | 86.3 |
| Battery 37 | LiNi_{0.8}Co_{0.15}Al_{0.03}Ta_{0.02}O₂ | PTFE | 7.1 | 86.0 |
| Battery 38 | LiNi_{0.8}Co_{0.15}Al_{0.03}Ti_{0.02}O₂ | PTFE | 7.5 | 85.4 |
| Battery 39 | LiNi_{0.8}Co_{0.15}Al_{0.03}Nb_{0.02}O₂ | PTFE | 8.0 | 85.1 |
| Battery 40 | LiNi_{0.5}Mn_{0.5}O₂ | PTFE | 11 | 82.3 |
| Battery 41 | LiNi_{0.3}Mn_{0.7}O₂ | PTFE | 12 | 81.6 |
| Battery 42 | LiNi_{0.5}Mn_{0.4}Co_{0.1}O₂ | PTFE | 11 | 82.0 |
| Battery 43 | LiNi_{1/3}Mn_{1/3}Co_{1/3}O₂ | PTFE | 12 | 81.7 |
| Battery 44 | LiNi_{0.33}Mn_{0.33}Co_{0.29}Al_{0.05}O₂ | PTFE | 7.2 | 85.8 |
| Battery 45 | LiNi_{0.33}Mn_{0.33}Co_{0.31}Al_{0.03}O₂ | PTFE | 7.3 | 85.6 |
| Battery 46 | LiNi_{0.33}Mn_{0.33}Co_{0.33}Al_{0.01}O₂ | PTFE | 7.9 | 85.2 |
| Battery 47 | LiNi_{0.33}Mn_{0.33}Co_{0.33}Y_{0.01}O₂ | PTFE | 8.0 | 85.0 |
| Battery 48 | LiNi_{0.8}Co_{0.15}Al_{0.05}O₂ | PTFE | 7.1 | 85.9 |
| | (80 wt %) + | | | |
| | LiNi_{1/3}Mn_{1/3}Co_{1/3}O₂ | | | |
| | (20 wt %) | | | |
| Battery 49 | LiNi_{0.8}Co_{0.15}Al_{0.05}O₂ | PTFE | 7.4 | 85.3 |
| | (80 wt %) + | | | |
| | LiCoO₂ (20 wt %) | | | |
| Battery 50 | LiNi_{1/3}Mn_{1/3}Co_{1/3}O₂ | PTFE | 13 | 80.7 |
| | (30 wt %) + | | | |
| | LiCoO₂ (70 wt %) | | | |

The results of Tables 2 and 3 reveal that the combination of a positive electrode active material represented by the formula: LiNiₓM_{1-x-y}Q_{y}O₂, where M is at least one of Co and Mn, Q is at least one selected from the group consisting of Al, Sr, Y, Zr, Ta, Mg, Ti, Zn, B, Ca, Cr, Si, Ga, Sn, P, V, Sb, Nb, Mo, W , and Fe, 0.1≦x≦1, and 0≦y≦0.1, and a separator including a polymer of a monomer containing halogen atoms but not containing a hydrogen atom makes it possible to provide a battery excellent in storage characteristics.

The results of Batteries 48 to 50 reveal that even when a mixture of positive electrode active materials represented by the foregoing formula, or a mixture of a positive electrode active material represented by the foregoing formula and a positive electrode active material other than this that does not contain Ni (e.g., LiCoO₂ etc.) is used, the metal deposition amount after storage is small and the capacity recovery rate is favorable.

The results of Batteries 3 to 10 reveal that the molar ratio x of Ni is preferably 0.1 to 0.9, more preferably 0.3 to 0.9, and particularly preferably 0.7 to 0.9.

Further, in Batteries 3 to 5, and in particular in Batteries 3 and 4, the molar ratio of Ni contained in the positive electrode active material was small, but the metal deposition amount was small and the capacity recovery rate was favorable as compared with those in Comparative Batteries 1 to 5. This result reveals that when Ni is contained in the positive electrode active material even in a small amount, the effect of the present invention can be obtained.

The results of Batteries 12 to 19 and 36 to 37 reveal that when element Q contained in the positive electrode active material is at least one selected from the group consisting of Al, Sr, Y, Zr and Ta, a battery excellent in storage characteristics can be obtained.

### Example 3

### Batteries 51 to 55

Batteries 51 to 55 were fabricated in the same manner as Battery 1 except that separators made of a material as shown in Table 4 were used.

With respect to Batteries 51 to 55, the metal deposition amount after storage and the capacity recovery rate were measured in the same manner as described above. In the measurement of the metal deposition amount after storage, the total amount of Ni and Co was referred to as the metal deposition amount. The results are shown in Table 4. The results of Batteries 1 to 2 are also shown in Table 4.

Acronyms for the constituent materials of the separator shown in Table 4 are as follows.

PCTFE: Polychlorotrifluoroethylene

PFA: Tetrafluoroethylene-perfluoroalkyl vinylether copolymer

FEP: Tetrafluoroethylene-hexafluoropropylene copolymer

PVDF-containing insulating layer: Insulating layer including polyvinylidene fluoride (PVDF) and alumina

PES-containing insulating layer: Insulating layer including polyethersulfone (PES) and alumina

Among the above, the separator made only of a polymer was prepared in the same manner as the foregoing separator made of PE. The thickness of these separators was 54 μm, and the porosity was 61%.

The PVDF-containing insulating layer and the PES-containing insulating layer were prepared in the same manner as the PAN-containing insulating layer except that polyvinylidene fluoride (solid content concentration: 8 wt %) and polyethersulfone (solid content concentration: 8 wt %) were used respectively in place of the modified polyacrylonitrile rubber binder.

TABLE 4

| | | | Metal | |
|---|---|---|---|---|
| | | | deposition | |
| | Positive | | amount | Capacity |
| | electrode | Constituent | after | recovery |
| | active | material of | storage | rate |
| | material | separator | (μg/g) | (%) |
| Battery 1 | LiNi_{0.8}Co_{0.2}O₂ | PTFE | 8.9 | 84.0 |
| Battery 51 | | PCTFE | 12 | 81.5 |
| Battery 52 | | PFA | 10 | 82.7 |
| Battery 53 | | FEP | 9.8 | 82.9 |
| Battery 2 | | PAN-containing | 9.1 | 83.8 |
| | | insulating layer | | |
| Battery 54 | | PVDF-containing | 9.8 | 82.9 |
| | | insulating layer | | |
| Battery 55 | | PES-containing | 10 | 82.6 |
| | | insulating layer | | |

From Table 4, it is found that even when the type of the constituent material of the separator is varied, if the separator includes a polymer of a monomer containing halogen atoms but not containing a hydrogen atom or includes an inorganic oxide, the amount of metal deposited on the negative electrode after storage is decreased and the capacity recovery rate is favorably improved. Presumably, this is because, as in the case above, metal cations leached from the positive electrode active material were trapped in an area surrounded by a region where the electron density was high on the surface of the positive electrode active material (oxygen atoms in NiO) and a region where the electron density was high in the separator (halogen atoms, or oxygen atoms in the inorganic oxide).

In addition, from Table 4, it is found that Battery 1 including the separator made of PTFE is particularly excellent in storage characteristics. PTFE includes in its repeating unit four fluorine atoms having the highest electron-withdrawing property and has little steric hindrance of polymer molecules. Because of this, the electron density of fluorine atoms in PTFE is uniform and high at any region. It is considered therefore that by using a nickel-containing lithium composite oxide as the positive electrode active material, as well as using the separator made of PTFE, metal cations leached from the positive electrode active material can be trapped more effectively.

Among the batteries including a layer made of an inorganic oxide and a polymer material, the storage characteristics of Battery 2 in which the foregoing layer included a polymer containing acrylonitrile units were particularly excellent. Presumably, this is because since the dispersibility of the polymer and the inorganic oxide in the layer was excellent, the metal cations were efficiently trapped.

### Example 4

### Batteries 56 to 59

Batteries 56 and 58 were fabricated in the same manner as Batteries 1 and 2, respectively, except that a reduction resistant film made of polyethylene (PE) (Hiporem available from Asahi Kasei Corporation, thickness: 20 μm) was disposed between the separator and the negative electrode.

Batteries 57 and 59 were fabricated in the same manner as Batteries 1 and 2, respectively, except that a reduction resistant film made of polypropylene (PP) available from Celgard K. K., thickness: 25 μm) was disposed between the separator and the negative electrode.

With respect to these batteries, the amount of metal deposited on the negative electrode after storage and the capacity recovery rate after storage were measured in the same manner as described above. In the measurement of the metal deposition amount after storage, the total amount of Ni and Co was referred to as the metal deposition amount. The results are shown in Table 5. It should be noted that the results of Batteries 1 to 2 are also shown in Table 5.

TABLE 5

| | | | Metal | |
|---|---|---|---|---|
| | Separator | | deposition | Capacity |
| | Negative | Positive | amount after | recovery |
| | electrode | Electrode | storage | rate |
| | side | side | (μg/g) | (%) |
| Battery 1 | PTFE | PTFE | 8.9 | 84.0 |
| Battery 56 | PE | PTFE | 6.0 | 87.5 |
| Battery 58 | PP | PTFE | 6.6 | 87.1 |
| Battery 2 | PAN- | PAN-containing | 9.1 | 83.8 |
| | containing | insulating layer | | |
| | insulating layer | | | |
| Battery 57 | PE | PAN-containing | 6.3 | 87.1 |
| | | insulating layer | | |
| Battery 59 | PP | PAN-containing | 6.9 | 86.8 |
| | | insulating layer | | |

As shown in Table 5, in Batteries 56 and 58 in which the reduction resistant film made of PE was disposed between the separator and the negative electrode, and in Batteries 57 and 59 in which the reduction resistant film made of PP was disposed between the separator and the negative electrode, the amounts of metal deposited on the negative electrode after storage were small as compared with those in Batteries 1 and 2. The capacity recovery rates of Batteries 56 to 59 were favorable as compared with the capacity recovery rates of Batteries 1 and 2. Presumably, this is because since the film made of PE or PP with high reduction resisting property was disposed in the negative electrode side, the reduction of the separator made of PTFE and the polymer containing acrylonitrile units in the PAN-containing insulating layer disposed in the positive electrode side was prevented.

### Example 5

### Battery 60

Battery 60 was fabricated in the same manner as Battery 1 except that a layer including an inorganic oxide was further provided on the negative electrode. In other words, in Battery 60, the separator includes a film made of PTFE and a layer including an inorganic oxide.

With respect to Battery 60, the amount of metal deposited on the negative electrode after storage and the capacity recovery rate after storage were measured in the same manner as described above. In the measurement of the metal deposition amount after storage, the total amount of Ni and Co was referred to as the metal deposition amount. The results are shown in Table 6. It should be noted that the results of Battery 1 are also shown in Table 6.

The layer including an inorganic oxide was fabricated on the negative electrode in the manner as describe below.

### [Fabrication Method of Layer Including Inorganic Oxide]

A paste was prepared by stirring 970 g of alumina having a median diameter of 0.3 μm, 375 g of N-methyl-2-pyrrolidone (NMP) solution (solid content: 8 wt %) including modified polyacrylonitrile rubber binder (BM-720H available from Zeon Corporation, Japan), and an appropriate amount of NMP with a double-arm kneader. This paste was applied onto both of the negative electrode active material layers on the negative electrode in a thickness of 5 μm, dried, and then further dried at 120° C. for 10 hours under 120° C. vacuum reduced pressure to form the layer including an inorganic oxide. The thickness of the paste applied onto the each negative electrode active material layer was 5 μm.

TABLE 6

| | | Metal deposition | Capacity |
|---|---|---|---|
| | | amount after | recovery |
| | | storage | rate |
| | Separator | (μg/g) | (%) |
| Battery 1 | PTFE | 8.9 | 84.0 |
| Battery 60 | PTFE + | 7.0 | 86.2 |
| | Insulating layer | | |

As shown in Table 6, in Battery 60 in which the separator includes a film made of PTFE and a layer including an inorganic oxide, the amount of metal deposited on the negative electrode after storage was small as compared with that in Battery 1. Moreover, the capacity recovery rate of Battery 60 was favorable as compared with the capacity recovery rate of Battery 1. Presumably, this was because since the separator additionally includes the layer including an organic oxide, and the layer including an organic oxide was disposed between the film made of PTFE and the negative electrode, the reduction of the separator was prevented.

### Example 6

In this Example, Battery 1 was used to measure the amount of metal deposited on the negative electrode after storage (total of Ni amount and Co amount) and the capacity recovery rate in the same manner as described above. In the measurement of these, the voltage during charge was set at 4.2V, 4.3V, 4.4V, 4.5V, 4.6V or 4.7V. The results are shown in Table 7.

TABLE 7

| | Metal deposition | |
|---|---|---|
| End-of-charge | amount after | Capacity recovery |
| Voltage | storage | rate |
| (V) | (μg/g) | (%) |
| 4.2 | 22 | 70.1 |
| 4.3 | 8.9 | 84.0 |
| 4.4 | 9.8 | 83.3 |
| 4.5 | 11 | 82.5 |
| 4.6 | 14 | 80.4 |
| 4.7 | 27 | 66.9 |

From Table 7, it is found that when a nickel-containing lithium composite oxide is used as the positive electrode active material and a separator including a polymer of a monomer containing halogen atoms but not containing a hydrogen atom, by setting the voltage during charge (i.e., end-of-charge voltage) at 4.3 to 4.6 V, the amount of metal deposited on the negative electrode after storage is remarkably decreased and the capacity recovery rate is favorably improved. The reason for this is considered as follows. The degree of expansion of a nickel-containing composite oxide serving as the positive electrode active material is increased as the end-of-charge voltage is set higher. By virtue of this, the non-aqueous electrolyte is allowed to easily enter the interior of the electrode, and the contact between the positive electrode and the non-aqueous electrolyte is improved. As a result, a local increase in voltage in the electrode is suppressed, and thus the voltage in the entire electrode is smoothed. However, when the end-of-charge voltage is lower than 4.3 V, since the degree of expansion of the positive electrode active material is low, only a small amount of non-aqueous electrolyte can enter the interior of the electrolyte. The charge reaction therefore proceeds on the surface of the electrode more intensively than in the interior, causing a local increase in voltage. Consequently, the non-aqueous solvent is decomposed by oxidation, and a great amount of metal cations are leached from the positive electrode active material. When the end-of-charge voltage is higher than 4.6 V, a local increase in voltage can be suppressed, but because of the excessively high voltage, oxidation decomposition of the non-aqueous solvent occurs. In this case also, a great amount of metal cations are leached from the positive electrode active material. In addition, in the cases where the end-of-charge voltage is lower than 4.3 V and is higher than 4.6 V, it is considered that since the amount of metal cations leached out is great, only a part of metal cations are trapped between the positive electrode and the separator, and the remaining metal cations are deposited on the negative electrode.

### INDUSTRIAL APPLICABILITY

In the non-aqueous electrolyte secondary battery of the present invention, even after stored under high voltage and high temperature, it is possible to suppress the deterioration in the rate performance. As such, the non-aqueous electrolyte secondary battery of the present invention can be used, for example, as a power source of equipment which may be stored at high temperature.

1. A non-aqueous electrolyte secondary battery comprising a positive electrode including a nickel-containing lithium composite oxide as a positive electrode active material, a negative electrode, a separator interposed between said positive electrode and said negative electrode, and a non-aqueous electrolyte, wherein said separator includes at least one selected from the group consisting of a layer including a polymer of a monomer containing halogen atoms but not containing a hydrogen atom and a layer including an inorganic oxide.

2. The non-aqueous electrolyte secondary battery in accordance with claim 1, wherein said nickel-containing lithium composite oxide includes a compound represented by the following formula:
LiNiₓM_{1-x-y}Q_{y}O₂
where M is at least one of Co and Mn, Q is at least one selected from the group consisting of Al, Sr, Y, Zr, Ta, Mg, Ti, Zn, B, Ca, Cr, Si, Ga, Sn, P, V, Sb, Nb, Mo, W, and Fe, 0.1≦x≦1, and 0≦y≦0.1.

3. The non-aqueous electrolyte secondary battery in accordance with claim 2, wherein element Q is at least one selected from the group consisting of Al, Sr, Y, Zr, and Ta.

4. The non-aqueous electrolyte secondary battery in accordance with claim 1, wherein said polymer is polytetrafluoroethylene.

5. The non-aqueous electrolyte secondary battery in accordance with claim 1, wherein said layer including an inorganic oxide includes at least one selected from the group consisting of a polymer containing acrylonitrile units, polyvinylidene fluoride, and polyethersulfone.

6. The non-aqueous electrolyte secondary battery in accordance with claim 1, wherein a reduction resistant film is provided between said separator and said negative electrode.

7. The non-aqueous electrolyte secondary battery in accordance with claim 6, wherein said reduction resistant film includes polyolefin.

8. The non-aqueous electrolyte secondary battery in accordance with claim 7, wherein said polyolefin is polyethylene or polypropylene.

9. A system comprising the non-aqueous electrolyte secondary battery in accordance with claim 1, and a charger for charging said non-aqueous electrolyte secondary battery, wherein an end-of-charge voltage in said charger is set at 4.3 to 4.6 V.
